(19) United States
(12) Patent Application Publication
(10) Pub. No.: US 2026/0219160 A1
(43) Pub. Date: Jul. 30, 2026

(54) APPARATUS AND METHOD FOR DETECTING AND/OR ANALYZING PARTICLES

(71) Applicant: K | LENS GMBH, Saarbrücken (DE)

(72) Inventors: Archana GUPTA, Bietigheim-Bissingen (DE); Tobias ELLINGHAUS, St. Ingbert (DE); Kireeti BODDUNA, Saarbrücken (DE); Sunil JAISWAL, Saarbrücken (DE); Simone FILOMENA, Saarbrücken (DE); Klaus ILLGNER-FEHNS, Starnberg (DE)

(21) Appl. No.: 19/144,268

(22) PCT Filed: Jan. 2, 2024
(86) PCT No.: PCT/EP2024/050046

§ 371 Date: Jun. 27, 2025

(30) Foreign Application Priority Data
Dec. 30, 2022 (LU) LU503287

(51) Int. Cl. G01N 15/1433; G01N 15/14

(52) U.S. Cl. CPC G01N 15/1433; G01N 15/1459

(57) ABSTRACT

An apparatus a method and a computer program product for detecting and/or analyzing particles, which apparatus includes a sample chamber within which the particles are to be detected, and a light source emitting light into the sample chamber. The apparatus includes an imaging system configured for capturing an imaging region provided for imaging light from the light source that is deflected by the particles, and a device for evaluating a recording of the imaging region created by the imaging system. The sample chamber is expediently formed within a container, which preferably contains a medium, in particular a liquid. The imaging region is formed by a wall of the container, the wall preferably being at least partially light-transmissive, preferably transparent or translucent.

The invention relates to an apparatus for detecting and/or analyzing particles, which comprises a sample space, inside which the particles are to be detected, and a light source that emits into the sample space.

The invention further relates to a method and to a computer program product for detecting and/or analyzing particles.

Such apparatuses for detecting and/or analyzing particles are known by use. However, the application possibilities are restricted.

The object of the present invention is to provide an apparatus of the type mentioned in the introduction, which covers a wider range of application.

According to the invention, this object is achieved in that the apparatus comprises an imaging system that is configured to acquire an imaging region, which is intended to image light from the light source that is deviated by the particles, and a device for evaluating a recording of the imaging region that is compiled by means of the imaging system.

The apparatus according to the invention on the one hand allows detection and analysis requiring comparatively little equipment outlay, and on the other hand particularly accurate detection results and analysis results can be achieved.

The detection and/or analysis of the particles expediently takes place with the aid of a structure, in particular a visible structure, which is formed by the deviated light in the imaging region. The structure is preferably a pattern that is formed by light which emanates from the light source and/or shadowing which is due to the particles. It has been found that the compositions, shapes, contours and sizes of the particles, as well as the number of these particles in the imaging region, generate structures with the aid of which the particles can be detected and/or analyzed. Furthermore, it has surprisingly been found that various particle types may be classified with the aid of the structure. In one embodiment of the invention, the classification takes place automatically by using a neural network, which has expediently been trained for classification and preferably object recognition of particles.

In one configuration of the invention, the sample space is formed inside a container, which preferably contains a medium, in particular a liquid. The container, in particular a wall of the container, may be formed by a flexible material. The flexible material is preferably a plastic film. Expediently, the container is a bag, preferably a bag for holding medical substances, for example an infusion bag or a dialysis bag.

Preferably, the light rays emanating from the light source strike the container, preferably exclusively, in a light entry region.

Expediently, the imaging region is formed by at least one imaging area. The imaging area may comprise a plane that is arranged perpendicularly with respect to an optical axis of an objective of the imaging system, expediently at a defined distance from the objective. Expediently, the objective is arranged at a distance from the plane such that it is possible to focus into the plane. It may be the case that a plurality of imaging areas, which are formed in the imaging region at different distances from the objective, are acquired. In this way, particles that are arranged at different distances from the imaging system in the sample space may be acquired particularly well. Preferably, the imaging region, in particular the imaging area, is formed on, at and/or inside the container, in particular inside the medium. Expediently, the imaging region, in particular the imaging area, is formed within a distance of 1 mm to 10 mm, preferably of 2 mm to 5 mm, from a wall of the container.

In one particularly preferred embodiment of the invention, at least one portion of the wall forms the imaging region. The wall and/or the imaging region is preferably permeable to light, preferably transparent or translucent, at least in portions.

In one configuration of the invention, the imaging system is a plenoptic imaging system. Plenoptic imaging systems have been found particularly advantageous when a plurality of imaging areas, which are formed at different distances from the objective in the imaging region, are intended to be acquired, since when recording by means of the plenoptic imaging system it is possible to record a plurality of such imaging areas with a single recording.

In one particularly preferred embodiment of the invention, the imaging system comprises a kaleidoscope. Such a kaleidoscope expediently comprises at least one pair of plane mirror surfaces, the mirror surfaces facing toward one another and being arranged at a distance from one another. At least some beam paths, preferably all beam paths, run through the space between the mirror surfaces. Preferably, mirror surfaces are arranged parallel to one another. The kaleidoscope may have two or more mirror pairs. A tube that is polygonal, preferably rectangular, in cross section may be formed from the mirror pairs. The kaleidoscope could alternatively be formed by a cylindrical glass rod, which is polygonal in cross section and has mirrored side surfaces and end surfaces for entry and exit of the light rays. In cross section, the glass rod preferably has the shape of an isosceles triangle, a rectangle, in particular a square, or a regular pentagon, hexagon, heptagon or octagon. Expediently, the mirrors and/or prisms are provided in such a way that the various images represent the object region recorded from different viewing angles. It is therefore possible to form a plenoptic camera.

The apparatus according to the invention is particularly suitable for detecting and analyzing particles, in particular translucent or transparent particles, which are suspended in the sample space, particularly in the medium, are optionally uniformly distributed and/or at least partially buoyant, float on the surface of the medium and/or sediment at the bottom of the sample space, in particular at the container bottom. Such particles have in particular edges that form an interface between the medium and the particles. Because of the different optical properties, in particular refractive index, the incident light of the light source is reflected, refracted and/or diffracted by the particles.

Advantageously, contours of the individual particles may be imaged with the aid of the light rays.

Expediently, the apparatus according to the invention is configured in such a way that the container, on the one hand, and the light source and/or the imaging system on the other hand, can be moved relative to one another. Advantageously, this makes it possible inter alia to inspect sample spaces, in particular containers, of different sizes.

In one particularly preferred configuration of the invention, the apparatus comprises a means for delivering the container, preferably a conveyor belt, a chute, in particular a tube, a channel, a hook, a cable and/or a gripping arm, and/or a carrier, in particular a basket, a tray and/or a base, in or on which the container can be arranged for the delivery. The possibility is available of successively inspecting a plurality of sample spaces, in particular a plurality of containers. It has been found particularly advantageous to use the apparatus, or the method, for testing and/or monitoring a production method in which objects, in particular containers, that comprise the sample spaces are generated. Expediently, the particle analysis and/or detection takes place at a rate which is similar, preferably identical or at least almost identical, to the rate at which the sample spaces, in particular the containers, are output in the production method. Carrying out the particle analysis and/or detection within a time<1 second becomes possible. Accordingly, the particle analysis and/or detection may be carried out at an extraordinarily high frequency.

By the delivery means, the container, particularly advantageously a multiplicity of the containers, may be transported in the apparatus or pulled or pushed along a surface. Preferentially, the delivery means and/or the carrier is intended to move the container past the light source and/or the imaging system. Alternatively or in addition, the light source and/or the imaging system could be moved past the container.

In one configuration of the invention, the delivery means and/or the carrier has a transmission region that is permeable to light, in such a way that the light from the light source can be emitted through the delivery means and/or the carrier and onto the light entry region. The light source or/and the imaging system is preferably arranged in the vicinity of the transmission region.

Expediently, the transmission region forms only a portion of the delivery means and/or of the carrier, and is preferably in the form of a slit.

It has been found particularly suitable to form the delivery device by at least one conveyor belt. The transmission region may be formed by a slit in the conveyor belt, the longitudinal axis of which preferably extends perpendicularly with respect to the delivery direction. The transmission region could also be formed by two conveyor belts being arranged at a distance from one another in the delivery direction and the transmission region being formed between the conveyor belts. Preferably, the conveyor belts are arranged in such a way that the container can be moved directly from one conveyor belt to the next conveyor belt.

In one embodiment of the invention, the light source on the one hand, and the imaging region and/or the imaging system on the other hand, are arranged on the same side and/or opposite sides of the delivery means, of the carrier, in particular of the transmission region, and/or of the container.

Expediently, the imaging system is arranged above or/and the light source is arranged below the transmission region and/or the container. In such an arrangement, particles that are buoyant, in particular floating, in the medium can be detected and/or analyzed particularly well.

If the imaging system is arranged below or/and the light source is arranged above the transmission region and/or the container, particles whose density is greater than that of the medium may be detected and/or analyzed particularly well.

In one particularly preferred embodiment of the invention, the light source on the one hand, and the imaging region or/and the imaging system on the other hand, are arranged on the same side of the container, of the delivery means and/or of the carrier, in particular of the transmission region. It has been found that particles which are suspended, buoyant and/or floating in the medium may be detected particularly well with this arrangement.

In one particularly preferred configuration of the invention, the apparatus is configured in such a way that no light rays emanating from the light source on an uninterrupted straight line strike the imaging region.

Expediently, the apparatus is provided in such a way that only light rays emanating from the light source that are deviated by the container and/or in the sample space, in particular by diffraction, refraction, reflection and/or the like, strike the imaging region.

In one embodiment of the invention, a stop is arranged between the light source and the imaging region or/and the imaging system. The stop is intended to keep the light rays emanating directly from the light source away from the imaging region. This can ensure that only light emanating from the light source that is deviated by the particles and/or, in particular by reflection, by the container impinges in the imaging region, in particular on the imaging area.

Preferably, the apparatus is configured in such a way that light rays emanating from the light source are kept away from the imaging system and/or the imaging region by at least a part of the delivery means, of the carrier and/or of the stop.

In one configuration of the invention, the container is arranged on an analysis surface. The analysis surface is expediently configured to form at least two different analysis backgrounds, which differ in their surface composition, refractive index, light reflection and/or absorption property, brightness, color and/or polarization.

Expediently, the analysis surface is configured to change, in particular switch, between the analysis backgrounds. The analysis surface could be an electronic paper, a polarization film or variable background lighting. Preferably, the analysis surface forms at least a part of the delivery means and/or of the carrier.

Expediently, a first analysis background is configured in such a way that it absorbs light differently, or emits light of a different intensity and/or wavelength, than a second analysis background. Expediently, the first analysis background is dark, in particular black. By means of such an analysis background, particles buoyant in the medium may be detected and/or analyzed particularly well.

The second analysis background is preferably bright, in particular white. In this way, particles having a greater density than the medium may be detected and/or analyzed particularly well.

It has been found that particularly good results have been able to be achieved in the analysis and/or detection of particles by arranging the imaging system and the light source above the container in conjunction with the analysis surface.

In one embodiment of the invention, the light rays that emanate from the light source and shine into the sample space are parallel or an angle between individual light rays among the light rays is less than 5°, preferably less than 2.5°, particularly preferentially less than 1°. In this way, particularly clear structures may be generated in the imaging region, in particular on the imaging area.

The light rays may be collimated. A diffuse lamp with a collimator, a laser, a laser array and/or a random pattern projector laser may be provided as the light source.

Expediently, an optical axis of an objective of the imaging system is arranged obliquely with respect to the light rays that emanate from the light source and shine into the sample space, the angle between the optical axis and the light rays preferably being at least 15° and/or at most 75°, particularly preferentially preferably at least 30° and/or at most 60°.

Preferably, the imaging region, in particular the imaging area, and/or a portion of the imaging region that is acquired by the imaging system is arranged offset with respect to the light entry region and/or the transmission region as seen in the vertical direction. Advantageously, in this way it is possible to generate particularly clear recordings of the imaging region.

In one embodiment of the invention, an angle at which the light rays penetrate into the transmission region and/or the sample space, or/and a distance of the light source from the sample space, is adjustable.

Expediently, an angle at which the optical axis of the objective of the imaging system records the sample space, the size of a recorded portion of the imaging region, in particular of the imaging area, the object distance of the objective or/and a distance of the imaging system from the sample space is adjustable.

In one development of the invention, the delivery means and/or the carrier, preferably the conveyor belt, has the same color as a marking, in particular lettering, provided on the container, which is preferably formed only on one side of the container.

Advantageously, this may prevent the marking from influencing an evaluation of the recordings.

Depending on the arrangement of the imaging system and of the light source in relation to the sample space, the container is arranged on the delivery means and/or the carrier in such a way that a side of the container on which the marking is formed rests on the delivery means and/or the carrier or faces away from the delivery means and/or the carrier. For the detection and/or analysis of buoyant and/or floating particles, the container is preferably arranged on the delivery means and/or the carrier in such a way that a side of the container on which the marking is formed rests on the delivery means and/or the carrier. For the detection and/or analysis of particles sedimented at the bottom of the sample space, the container is preferably arranged on the delivery means and/or the carrier in such a way that a side of the container on which the marking is formed faces away from the delivery means and/or the carrier.

According to the invention, the imaging system, particularly preferentially the plenoptic imaging system, comprises a camera, preferably a line scan camera, a digital area scan camera and/or a plenoptic camera. Preferably, the light source emits visible light and the imaging system is intended to acquire visible light. Depending on the application, it is also conceivable to provide UV or IR light sources and an imaging system respectively adapted thereto, in which case a polarizer that can make the imaging features more clearly recognizable is preferably arranged in the imaging system and/or in front of the objective.

In one particularly preferred configuration of the invention, the apparatus is configured to distinguish structures that are due to particles from those that are caused by perturbing bodies.

The perturbing bodies may be one or more bubbles that are formed in the medium, or one or more moldings of the container, which lead to the formation of structures in the imaging region.

If recordings in which the same imaging region is imaged at least in portions are compiled, analysis and/or detection may be carried out with greater reliability. The possibility is available of comparing and/or evaluating the results of the analysis and/or detection that are achieved with the aid of individual recordings among the recordings. It has further been found advantageous for the particles, in particular respectively the same particle, and/or the perturbing bodies, in particular respectively the same perturbing body, to be represented at various positions in the different recordings. A particularly robust measurement may take place, since the angle of incidence at the interface between the substance and the particle, or the perturbing body, changes according to the arrangement of the particle and/or of the perturbing body with respect to the light rays, and by the multiple recordings it is possible to ensure that the structures of all the particles, or perturbing bodies, that are formed in the imaging region are imaged at least in one of the recordings.

Because the particles have different optical properties, shapes and/or contours in comparison to the perturbing bodies, different structures, in particular with a different color, brightness, contour and/or shape, are generated in the imaging region. It has been found that the structures respectively caused by the same particles in the various recordings differ much less strongly than the structures caused by perturbing bodies. In this way, the particles may be distinguished particularly well from the perturbing bodies.

This moreover allows particularly good analysis by means of a neural network and is advantageous for training of a neural network.

In one configuration of the invention, a frequency with which the imaging system generates the recordings is matched with a movement speed at which the container and the recording device are moved relative to one another. Expediently, the recording frequency and the movement speed are matched to one another in such a way that the same portion of the container and/or of the sample space is acquired multiple times in the imaging region. The same portion may then be represented at different positions in various recordings.

Preferably, the recording frequency and the movement speed are matched to one another in such a way that the container is fully acquired, preferably in portions, by the generation of a plurality of recordings. The full acquisition may, for example, take place by generating at least two recordings that each acquire the container only partially.

Expediently, the imaging system has a plurality of cameras which, in the movement direction of the container relative to the imaging system, are preferably arranged laterally offset with respect to one another and/or successively. Advantageously, the instants at which the plurality of cameras record are synchronized or temporally offset with respect to one another, preferably as a function of the movement speed. The plurality of cameras could be configured to acquire different imaging regions, which are preferably arranged in a row.

Preferably, a plurality of imaging systems are provided so that a plurality of imaging regions can be recorded, in particular simultaneously. Preferably, the plurality of imaging regions are arranged successively in the delivery direction. At least one imaging region could be arranged in the delivery direction in front of the light entry region and/or the transmission region, and at least one other light entry region could be arranged behind the latter.

Expediently, the imaging system has an optical filter so that the light rays impinging in the imaging region can be selected according to the wavelength and/or direction of incidence.

In one further configuration of the invention, the evaluation device comprises a computer, which by means of a computer program is configured to ascertain whether there are particles in the sample space, and/or to determine properties of the particles, automatically from the recording.

The computer program product for detecting and/or analyzing particles is expediently configured to detect and/or analyze the particles automatically from a recording of the imaging region that is compiled by means of the imaging system.

Expediently, the particles are detected and/or analyzed with the aid of the structure reproduced in the imaging region, preferably the imaging area.

In one embodiment of the invention, the computer program is configured to determine the number of particles in the sample space.

The computer program product expediently comprises a neural network, which is trained to ascertain whether there are particles in the sample space, and/or to determine properties of the particles, automatically from the recording.

The structures may be analyzed particularly well by means of a neural network. Advantageously, the neural network may be trained to take into account only structures generated by particles in the sample space and to ignore and/or distinguish those of perturbing bodies in the medium.

Expediently, the neural network is trained to recognize the particles and/or the perturbing bodies, and/or to classify them into different categories, optionally according to their type and/or their appearance, for example the particles into the following categories: fibers (for example of gloves), swarf, hairs, transparent particles (for example of tubes, connecting pieces or the like), semitransparent particles, nontransparent, optionally dark particles, soft or solid particles (for example rubber, seals or the like), and optionally the perturbing bodies into bubbles, container moldings, etc.

Preferably, the neural network is trained to recognize and optionally classify various particles in the same recording. It is to be understood that the neural network may be trained to recognize and optionally classify various particles in two or more recordings. It may be the case that the neural network is trained to recognize whether the same particle is imaged in various recordings. Expediently, this is taken into account in the analysis and/or detection, in particular in the determination of the number of particles in the sample space. This advantageously prevents structures that are attributable to the same particle from leading to multiple counting of the particle.

Results of the object recognition and optionally of the classification relating to the same particle may be compared and/or evaluated. Preferably, the results are weighted according to a result of the evaluation.

In one embodiment of the invention, the apparatus is configured to mark and/or reject a container in which a particle has been detected. The apparatus may be intended to mark and/or reject a container only in the event of a particular condition. Expediently, the condition comprises a limiting number of detected particles or/and at least one particle of a particular category being found.

In one development of the invention, the apparatus according to the invention is connected, preferably directly, to a device for producing a multiplicity of the container filled with the medium, preferably in such a way that containers filled with the medium can be inspected by means of the apparatus after their production, preferentially immediately after their production. Expediently, the apparatus according to the invention comprises the aforementioned production device.

The invention is explained in more detail below with the aid of several exemplary embodiments and drawings, which relate to the exemplary embodiments. In the figures, schematically:

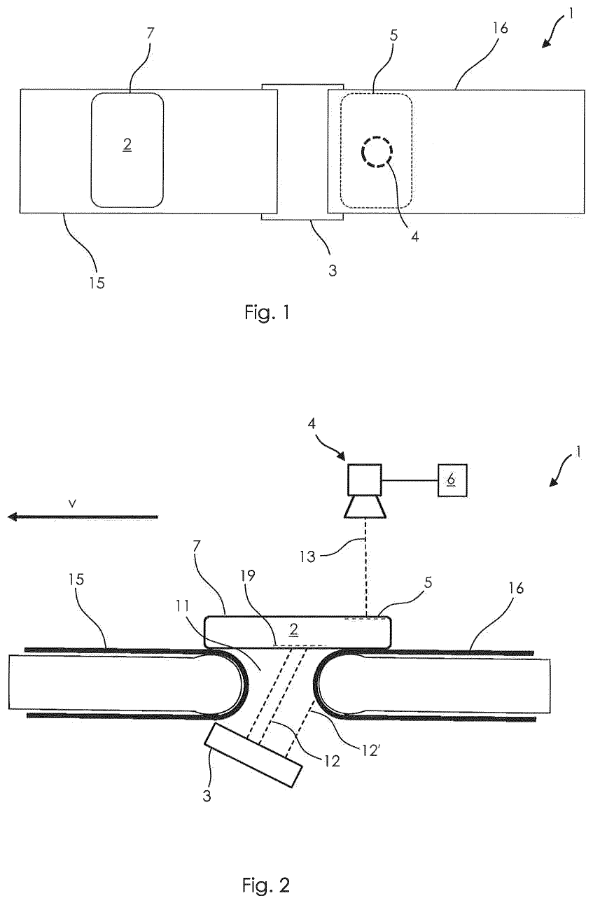

FIG. 1 shows an apparatus according to the invention in plan view,

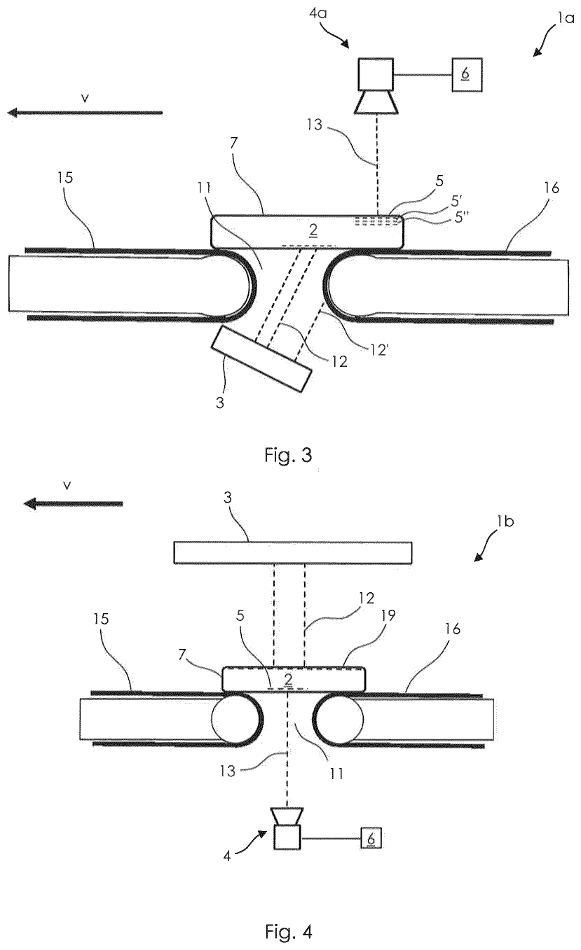

FIGS. 2 and 3 show an apparatus according to FIG. 1 in a side view,

FIG. 4 shows a further apparatus according to the invention in a side view, and

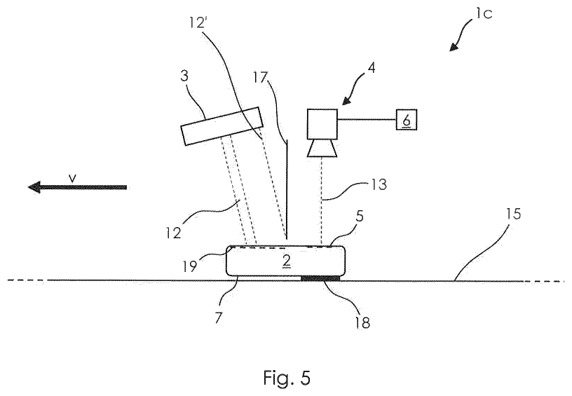

FIG. 5 shows a further apparatus according to the invention in a side view.

An apparatus 1 according to the invention, which is partially represented in FIG. 1, has two conveyor belts 15,16, which are arranged at a distance from one another in such a way that a bag 7 filled with a liquid can be moved from the first conveyor belt 16 as seen in the delivery direction v onto the second conveyor belt 15. It is to be understood that the bag 7 may also be moved in the direction opposite to the delivery direction v shown.

As may be seen in FIG. 2, a light source 3 that emits substantially parallel light rays 12,12′ is arranged below the conveyor belts 15,16. The light rays 12, which penetrate through a transmission region 11 that is formed in the opening between the conveyor belts 15,16, impinge on a light entry region 19 that is formed on a lower wall of the bag 7 and shine into a sample space 2 formed in the bag 7. The light rays 12′ are blocked by the conveyor belts 15,16.

Offset with respect to the transmission region 11, an imaging system 4 is arranged above the conveyor belts 15,16, which is aligned and set in such a way that an upper wall of the bag 7, which forms an imaging area 5, can be recorded. Alternatively, the imaging area 5 could be formed at a distance of 1 mm to 10 mm from the upper wall of the bag 7, inside the liquid.

The imaging system 4 may be arranged in such a way that only a region of the upper wall of the bag that is arranged offset as seen in the vertical direction with respect to the transmission region 11 and the light entry region 19 is acquired. In the present example, an optical axis 13 of an objective of the imaging system 4 is arranged vertically. The imaging area 5 is formed perpendicularly with respect to the optical axis 13. Alternatively, the imaging system 4 could be aligned so that the optical axis 13 is arranged obliquely with respect to the imaging area 5.

An angle at which the optical axis 13 of the objective of the imaging system 4 records the sample space 2, the size of the recorded region of the imaging area 5, the object distance of the objective or/and a distance of the imaging system 4 from the sample space 2 may be adjustable.

The light source 3 is arranged in such a way that light rays 12 which emanate directly from the light source 3 penetrate into the sample space 2 obliquely, in the present example at an angle of 30° with respect to the optical axis 13. The distance of the light source 3 from the sample space 2 and the angle of the incident light rays 12 with respect to the optical axis 13 are likewise adjustable.

If the bag 7, which has a transparent and flexible wall, is transported across the transmission region 11, the light rays 12 from the light source 3 strike the bag 7 and penetrate into the sample space 2 that is formed in the bag 7.

By the light rays 12, a visible structure is formed on the upper wall of the bag 7, which is a pattern that is due to light which emanates from the light source and/or shadowing which is due to the particles. The pattern that is formed is formed as a function of the bag content and therefore of the content of the sample space 2. In particular, the structures are formed differently as a function of whether there are particles and possibly air bubbles in the liquid. It is to be understood that the structures may also be invisible, depending on whether the light source 3 emits visible or invisible light. In this case, the imaging system 4 is also configured in such a way as to acquire invisible light.

By means of the imaging system 4, digital recordings of the imaging area 5 are generated and sent to an evaluation device 6. The frequency with which the imaging system 4 generates a plurality of recordings, and the movement speed of the conveyor belts 15,16, are selected in such a way that the bag 7 is acquired fully by the plurality of recordings of various regions of the bag 7. Identical regions of the bag 7 may be acquired in portions in various recordings.

The structures formed by individual particles may possibly be imaged in a plurality of recordings. It is to be understood that the entire bag 7 could also be acquired by a single recording.

The evaluation device 6, which comprises a computer, ascertains by means of a computer program whether there are particles in the liquid and analyses the particles. The computer program may comprise a neural network that has been trained to detect and/or analyze the particles from the recordings of the imaging area 5.

The neural network is trained to recognize particles in the recording. It may be trained in such a way that it can recognize various particles in the same recording.

The neural network is trained in such a way that it recognizes structures in various recordings that are generated by the same particle. In this way, it is possible to prevent multiple counting of the same particle and erroneous determination of the number, or of the particle content, from occurring.

The neural network is alternatively or in addition trained to classify the particles into different categories, optionally according to their type and/or their appearance, for example into fibers, swarf, hairs, transparent, semitransparent, translucent, nontransparent and/or dark particles, and optionally soft or solid particles.

The computer program ascertains the number of particles contained in the sample space 2.

The apparatus 1 is configured to label and/or reject a bag 7 in which a particle has been detected. The apparatus 1 may be intended to label and/or reject a bag 7 only in the event of a particular condition. Expediently, the condition comprises a limiting number of detected particles or/and at least one particle of a particular category being found. It is to be understood that the labeling may take place merely digitally in the computer program.

By means of the computer program, a bag 7 to be rejected may be caused to be removed by means of a rejection device (not shown here).

In the exemplary embodiment according to FIG. 3, unlike in the example according to FIG. 2, recordings are compiled in a plurality of imaging areas 5,5′,5″, which have different distances from the imaging system 4a and therefore image different positions in the bag 7. The imaging system 4a of the apparatus 1a is in the present example a plenoptic camera which, with the aid of a single recording, can acquire the imaging areas 5,5′,5″ that are employed for the detection and/or analysis. The imaging system 4a could instead, or in addition, have at least one line scan camera and/or at least one digital area scan camera, by means of which at least one recording is made of each imaging area 5,5′,5″ to be acquired. Advantageously, in this way, particles that float in the interior of the bag and are arranged at a distance from the upper wall of the bag may be acquired particularly well.

In contrast to the exemplary embodiment shown in FIG. 2, in the exemplary embodiment according to FIG. 4 the imaging system 4 is arranged below the conveyor belts 15,16 and the transmission region 11. The imaging area 5 is formed 5 mm above the lower wall of the bag 7, although it could also be arranged at a different distance between 1 mm and 10 mm from the wall. The light rays 12 of the light source 3 shine through the bag 7 from above and form visible structures, which comprise a pattern of light and shadowing, on the imaging area 5. By this arrangement, particles whose density is greater than that of the medium and which are arranged in the lower region of the bag 7, and possibly sediment on the bottom of the bag, may be detected and analyzed particularly well.

The apparatuses 1; 1a shown in FIG. 2 and FIG. 3 may be combined with the apparatus 1b according to FIG. 4.

It is to be understood that in the case of bags with a small thickness, the depth of focus of the optics of the imaging system may be provided in such a way that particles from the bottom of the bag as far as the upper wall of the bag, in particular particles sedimented, buoyant and floating in the liquid, can be recognized.

In the exemplary embodiment according to FIG. 5, the light source 3 and the imaging system 4 are arranged on the same side of the bag 7, or of the conveyor belt 15. In order for light rays 12′ that would otherwise impinge directly on the imaging area 5 to be kept away from the imaging area 5, a stop 17 is arranged between the light source 3 and the imaging system 4.

An analysis surface in the form of an electronic paper 18 may be arranged under the bag 7. The analysis surface is part of a transport area (not shown here), for example a tray, in which the bag 7 lies. The bag does not move relative to the transport area, but the transport area/tray or/and the imaging system is moved. In order to detect particles that have a greater density than the liquid, a white side which forms an analysis background is displayed by means of the electronic paper 18. This increases the contrast with respect to the particles. If particles buoyant in the medium are intended to be detected, a black side which forms another analysis background is displayed by means of the electronic paper 18. This prevents light that is not deviated by the particles from impinging on the imaging area 5, for example because of reflections at a surface of the tray.

Instead of the electronic paper 18, a bright, in particular white base may be provided, which is arranged below the bag 7 in alternation with a dark, in particular black base. Further, a polarization film could be arranged under the bag 7, in which case recordings of the imaging area 5 with a white or black background may be recorded by means of a polarization filter provided in the imaging system 4. Further, planar background lighting could be provided below the bag 7, which when switched on forms a bright background and when switched off forms a dark background of the imaging area 5.

It is to be understood that the bags 7 are mentioned only by way of example above, and the described method may be carried out with a different container instead of the bag 7, or the described apparatus 1 for particle analysis and/or detection may be used and/or provided in a different container. The container could, for example, be a container consisting of a solid material, which has at least one wall that is permeable to light, preferably transparent or translucent, in portions.

1-25. (canceled)

26. An apparatus for detecting and/or analyzing particles, comprising: a sample space, inside which the particles are to be detected;
a light source that emits into the sample space;
an imaging system configured to acquire an imaging region which is intended to image light from the light source that is deviated by the particles; and
a device for evaluating a recording of the imaging region that is compiled by the imaging system.

27. The apparatus according to claim 26, wherein no light rays emanating from the light source on an uninterrupted straight line strike the imaging region.

28. The apparatus according to claim 26, wherein the sample space is formed inside a container.

29. The apparatus according to claim 28, wherein the container contains a medium.

30. The apparatus according to claim 29, wherein the container contains a liquid.

31. The apparatus according to claim 29, wherein only light rays emanating from the light source that are deviated by the particles and/or perturbing bodies in the sample space strike the imaging region.

32. The apparatus according to claim 31, wherein only light rays emanating from the light source that are deviated by diffraction, refraction and/or reflection strike the imaging region.

33. The apparatus according to claim 26, wherein the container has a wall that is, at least in portions, permeable to light and forms the imaging region, or/and the imaging region is arranged in the sample space.

34. The apparatus according to claim 33, wherein the container wall is transparent or translucent.

35. The apparatus according to claim 33, wherein the imaging region is arranged in the sample space within a distance of 1 mm to 10 mm from the wall.

36. The apparatus according to claim 35, wherein the imaging region is arranged in the sample space within a distance of 2 mm to 5 mm from the wall.

37. The apparatus according to claim 28, wherein the container consists of a solid material or is a bag.

38. The apparatus according to claim 37, wherein the container is a bag for holding medical substances.

39. The apparatus according to claim 38, wherein the bag is an infusion bag or a dialysis bag.

40. The apparatus according to claim 28, wherein the light source is configured so that light rays that emanate from the light source and shine onto a light entry region of the container and into the sample space are at least substantially parallel.

41. The apparatus according to claim 40, wherein the imaging system has an objective with an optical axis arranged obliquely with respect to the light rays so that an angle between the optical axis and the light rays is at least 15° and/or at most 75°.

42. The apparatus according to claim 41, wherein the angle between the optical axis and the light rays is at least 30° and/or at most 60°.

43. The apparatus according to claim 40, comprising a device for delivering the container and/or a carrier, in or on which the container is arranged for the delivery.

44. The apparatus according to claim 43, wherein the device for delivering is a conveyor belt.

45. The apparatus according to claim 43, wherein the delivery device and/or the carrier has a transmission region that is permeable to light so that the light from the light source can be emitted through the delivery device and/or the carrier.

46. The apparatus according to claim 45, wherein the transmission region forms only a portion of the delivery device and/or of the carrier.

47. The apparatus according to claim 46, wherein the transmission region is as a slit.

48. The apparatus according to claim 43, wherein the light source and the imaging region or/and the imaging system are arranged on a common side of the container, of the delivery device and/or of the carrier.

49. The apparatus according to claim 45, wherein the light source on the one hand, and the imaging region or/and the imaging system on the other hand, are arranged on opposite sides of the container and/or of the delivery device, in particular of the transmission region.

50. The apparatus according to claim 45, wherein as seen in a vertical direction, the imaging region and/or a portion of the imaging region that is acquired by the imaging system is arranged offset with respect to the light entry region and/or the transmission region.

51. The apparatus according to claim 45, wherein an angle at which the light rays penetrate into the light entry region, transmission region and/or the sample space, or/and a distance of the light source from the sample space, is adjustable.

52. The apparatus according to claim 41, wherein an angle at which the optical axis of the objective of the imaging system records the sample space, a size of the recorded portion of the imaging region, an object distance of the objective or/and a distance of the imaging system from the sample space is adjustable.

53. The apparatus according to claim 43, wherein the delivery device and the container have a common color as a marking.

54. The apparatus according to claim 26, wherein the evaluation device comprises a computer, which, by way of a computer program, is configured to ascertain whether there are particles in the sample space, and/or to determine properties of the particles, automatically from the recording.

55. The apparatus according to claim 54, wherein the computer program carries out the following steps:
emitting light from a light source into the sample space; imaging the light from the light source that is deviated by the particles in an imaging region; acquiring the imaging region in an imaging system; compiling a recording of the imaging region using the imaging system; and evaluating the recording with an evaluating device.

56. A method for detecting and/or analyzing particles that are arranged in a sample space, comprising the steps of: emitting light from a light source into the sample space; imaging the light from the light source that is deviated by the particles in an imaging region; acquiring the imaging region in an imaging system; compiling a recording of the imaging region using the imaging system; and evaluating the recording with an evaluating device.

57. The apparatus according to claim 56, wherein the sample space is formed inside a container that contains a medium.

58. The apparatus according to claim 57, wherein the medium is a liquid

59. The apparatus according to claim 57, wherein the imaging region is formed by a wall of the container.

60. The apparatus according to claim 59, wherein the wall is permeable to light at least in portions.

61. The apparatus according to claim 60, wherein the wall is transparent or translucent.

62. A computer program product for detecting and/or analyzing particles, which is configured to ascertain whether there are particles in a sample space, and/or to determine properties of the particles, automatically from a recording of an imaging region that is compiled by an imaging system, in which imaging region light from a light source that is deviated by the particles is imaged.

63. The computer program product according to claim 62, wherein the particles are detected and/or analyzed with aid of a visible structure that is reproduced in the imaging region.

64. The computer program product according to claim 48, comprising a neural network that is trained to ascertain whether there are particles in the sample space, and/or to determine properties of the particles, automatically from the at least one recording.
